(19) United States
(12) Patent Application Publication
(10) Pub. No.: US 2025/0183947 A1
(43) Pub. Date: Jun. 5, 2025

(54) FULL TRANSMIT POWER BEAMFORMING FOR SINGLE USER MULTI-INPUT MULTI-OUTPUT TRANSMISSION

(71) Applicant: QUALCOMM Incorporated, San Diego, CA (US)

(72) Inventors: Wenquan HU, Espoo (FI); Mark WALLACE, Bedford, MA (US)

(21) Appl. No.: 18/528,566

(22) Filed: Dec. 4, 2023

(51) Int. Cl. H04B 7/0426; H04B 7/0456; H04L 5/00

(52) U.S. Cl. CPC H04B 7/043; H04B 7/046; H04L 5/0042

(57) ABSTRACT

Methods, systems, and devices for wireless communications are described. A network entity may obtain a single user, multi-input multi-output (SU-MIMO) channel between the network entity and a user equipment (UE), which may correspond to multiple SU-MIMO layers. The network entity may generate a transformed channel based on a selection of the multiple SU-MIMO layers. The selection may be based on a singular value decomposition (SVD) of the SU-MIMO channel, or a set of receive antennas at the UE, or a combination thereof. The network entity may generate an intermediate beamformer based on the transformed channel and may generate a per antenna full transmit power beamformer based on the intermediate beamformer. The network entity may output a beamformed signal to the UE, and a respective beamforming weight for each SU-MIMO layer of the multiple SU-MIMO layers may be based on the per antenna full transmit power beamformer.

### FIELD OF TECHNOLOGY

The following relates to wireless communications, including full transmit power beamforming for single user multi-input multi-output transmission (SU-MIMO).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support full transmit power beamforming for single user multi-input multi-output transmission (SU-MIMO). For example, the described techniques provide for a network entity determining beamforming weights for transmitting a beamformed signal based on a channel that is transformed from an SU-MIMO channel. The transformed channel may be a singular value decomposition (SVD) of the SU-MIMO channel or a subset of the SU-MIMO channel that is selected based on a set of receive antennas at the UE. The network entity may generate an intermediate beamformer based on the transformed channel and may perform distribution of transmit power across multiple layers of the SU-MIMO channel using a per antenna full transmit power beamformer to determine the beamforming weights for each SU-MIMO layer. The network entity may output a beamformed signal to a user equipment (UE) using the beamforming weights.

A method for wireless communications by a network entity is described. The method may include obtaining an SU-MIMO channel between the network entity and a UE, where the SU-MIMO channel corresponds to a set of multiple SU-MIMO layers, generating a transformed channel from the SU-MIMO channel based on a selection of the set of multiple SU-MIMO layers, the selection based on a SVD of the SU-MIMO channel, or a set of receive antennas at the UE, or a combination thereof, generating an intermediate beamformer based on the transformed channel, generating a per antenna full transmit power beamformer based on the intermediate beamformer, and outputting a beamformed signal to the UE, where a respective beamforming weight for each SU-MIMO layer of the set of multiple SU-MIMO layers is based on the per antenna full transmit power beamformer.

A network entity for wireless communications is described. The network entity may include one or more memories storing processor executable code, and one or more processors coupled with the one or more memories. The one or more processors may individually or collectively operable to execute the code to cause the network entity to obtain an SU-MIMO channel between the network entity and a UE, where the SU-MIMO channel corresponds to a set of multiple SU-MIMO layers, generate a transformed channel from the SU-MIMO channel based on a selection of the set of multiple SU-MIMO layers, the selection based on a SVD of the SU-MIMO channel, or a set of receive antennas at the UE, or a combination thereof, generate an intermediate beamformer based on the transformed channel, generate a per antenna full transmit power beamformer based on the intermediate beamformer, and output a beamformed signal to the UE, where a respective beamforming weight for each SU-MIMO layer of the set of multiple SU-MIMO layers is based on the per antenna full transmit power beamformer.

Another network entity for wireless communications is described. The network entity may include means for obtaining an SU-MIMO channel between the network entity and a UE, where the SU-MIMO channel corresponds to a set of multiple SU-MIMO layers, means for generating a transformed channel from the SU-MIMO channel based on a selection of the set of multiple SU-MIMO layers, the selection based on a SVD of the SU-MIMO channel, or a set of receive antennas at the UE, or a combination thereof, means for generating an intermediate beamformer based on the transformed channel, means for generating a per antenna full transmit power beamformer based on the intermediate beamformer, and means for outputting a beamformed signal to the UE, where a respective beamforming weight for each SU-MIMO layer of the set of multiple SU-MIMO layers is based on the per antenna full transmit power beamformer.

A non-transitory computer-readable medium storing code for wireless communications is described. The code may include instructions executable by one or more processors to obtain an SU-MIMO channel between the network entity and a UE, where the SU-MIMO channel corresponds to a set of multiple SU-MIMO layers, generate a transformed channel from the SU-MIMO channel based on a selection of the set of multiple SU-MIMO layers, the selection based on a SVD of the SU-MIMO channel, or a set of receive antennas at the UE, or a combination thereof, generate an intermediate beamformer based on the transformed channel, generate a per antenna full transmit power beamformer based on the intermediate beamformer, and output a beamformed signal to the UE, where a respective beamforming weight for each SU-MIMO layer of the set of multiple SU-MIMO layers is based on the per antenna full transmit power beamformer.

In some examples of the method, network entities, and non-transitory computer-readable medium described herein, outputting the beamformed signal may include operations, features, means, or instructions for outputting the beamformed signal at an equal transmit power across the set of multiple SU-MIMO layers based on the per antenna full transmit power beamformer, where an amplitude of the respective beamforming weight for each SU-MIMO layer of the set of multiple SU-MIMO layers may be the same.

Some examples of the method, network entities, and non-transitory computer-readable medium described herein may further include operations, features, means, or instructions for performing a power normalization of the per antenna full transmit power beamformer on each transmit antenna of a set of multiple transmit antennas corresponding to the set of multiple SU-MIMO layers, where each SU-MIMO layer of the set of multiple SU-MIMO layers may be assigned the respective beamforming weight based on the power normalization.

In some examples of the method, network entities, and non-transitory computer-readable medium described herein, generating the transformed channel may include operations, features, means, or instructions for performing the SVD of the SU-MIMO channel to obtain a subset of a left singular matrix associated with the SU-MIMO channel, where the subset of the left singular matrix satisfies a channel quality threshold.

In some examples of the method, network entities, and non-transitory computer-readable medium described herein, the transformed channel may be based on a multiplication of the SU-MIMO channel with a Hermitian of the subset of the left singular matrix that satisfies the channel quality threshold.

Some examples of the method, network entities, and non-transitory computer-readable medium described herein may further include operations, features, means, or instructions for selecting the set of receive antennas based on applying one or more functions to the SU-MIMO channel, where a first quantity of the set of receive antennas may be less than a second quantity of the set of multiple SU-MIMO layers.

In some examples of the method, network entities, and non-transitory computer-readable medium described herein, outputting the beamformed signal may include operations, features, means, or instructions for outputting the beamformed signal via a set of multiple resource blocks, where the respective beamforming weights may be calculated for each resource block of the set of multiple resource blocks.

In some examples of the method, network entities, and non-transitory computer-readable medium described herein, the intermediate beamformer may be a matched filter beamformer, and the method, network entities, and non-transitory computer-readable medium described herein may further include operations, features, means, or instructions for applying the matched filter beamformer to the transformed channel, where the respective beamforming weight for each SU-MIMO layer of the set of multiple SU-MIMO layers may be based on applying the matched filter beamformer.

In some examples of the method, network entities, and non-transitory computer-readable medium described herein, the intermediate beamformer may be a zero-forcing beamformer or a regularized zero-forcing beamformer, and the method, network entities, and non-transitory computer-readable medium described herein may further include operations, features, means, or instructions for applying the zero-forcing beamformer or the regularized zero-forcing beamformer to the transformed channel, where the respective beamforming weight for each SU-MIMO layer of the set of multiple SU-MIMO layers may be based on applying the zero-forcing beamformer or the regularized zero-forcing beamformer.

### BRIEF DESCRIPTION OF THE DRAWINGS

FIG. 1 shows an example of a wireless communications system that supports full transmit power beamforming for single user multi-input multi-output (SU-MIMO) transmission in accordance with one or more aspects of the present disclosure.

FIG. 2 shows an example of a wireless communications system that supports full transmit power beamforming for SU-MIMO transmission in accordance with one or more aspects of the present disclosure.

FIG. 3 shows an example of a process flow that supports full transmit power beamforming for SU-MIMO transmission in accordance with one or more aspects of the present disclosure.

FIG. 4 shows an example of a process flow that supports full transmit power beamforming for SU-MIMO transmission in accordance with one or more aspects of the present disclosure.

FIGS. 5 and 6 show block diagrams of devices that support full transmit power beamforming for SU-MIMO transmission in accordance with one or more aspects of the present disclosure.

FIG. 7 shows a block diagram of a communications manager that supports full transmit power beamforming for SU-MIMO transmission in accordance with one or more aspects of the present disclosure.

FIG. 8 shows a diagram of a system including a device that supports full transmit power beamforming for SU-MIMO transmission in accordance with one or more aspects of the present disclosure.

FIGS. 9 through 11 show flowcharts illustrating methods that support full transmit power beamforming for SU-MIMO transmission in accordance with one or more aspects of the present disclosure.

### DETAILED DESCRIPTION

To communicate with a user equipment (UE), a network entity may utilize a single-user, multi-input, multi-output (SU-MIMO) configuration. Using the SU-MIMO configuration, the network entity may communicate with the UE via multiple SU-MIMO layers, which may correspond to receive antennas at the UE and transmit antennas at the network entity. Each transmit antenna at the network entity may be driven by an independent power amplifier, and there may be a maximum transmit power limit on each transmit antenna. Because of the per antenna maximum transmit power limit, beamforming schemes for determining a beamforming weight for each layer of the multiple MIMO layers may take a long time to compute or may be associated with a high complexity of implementation.

The network entity may implement a full transmit power beamforming scheme for SU-MIMO transmissions. For example, the network entity may generate a transformed channel based on a selection of layers from a set of layers corresponding to an SU-MIMO channel. In some examples, the transformed channel may be based on singular value decomposition (SVD) processing of the SU-MIMO channel. In other examples, the transformed channel may be based on selecting a subset of the SU-MIMO channel based on one or more performance or channel quality metrics. The network entity may generate a per antenna full transmit power beamformer that assigns a beamforming weight to each layer of the set of layers corresponding to the SU-MIMO channel. The full transmit power beamformer may apply an equal transmit power across layers of the SU-MIMO channel, or the per antenna full transmit power beamformer may perform a power normalization for each transmit antenna of a set of antennas at the network entity.

Aspects of the disclosure are initially described in the context of wireless communications systems. Aspects of the disclosure are further described in the context of wireless communications systems and process flows. Aspects of the disclosure are further illustrated by and described with reference to apparatus diagrams, system diagrams, and flowcharts that relate to full transmit power beamforming for SU-MIMO transmission.

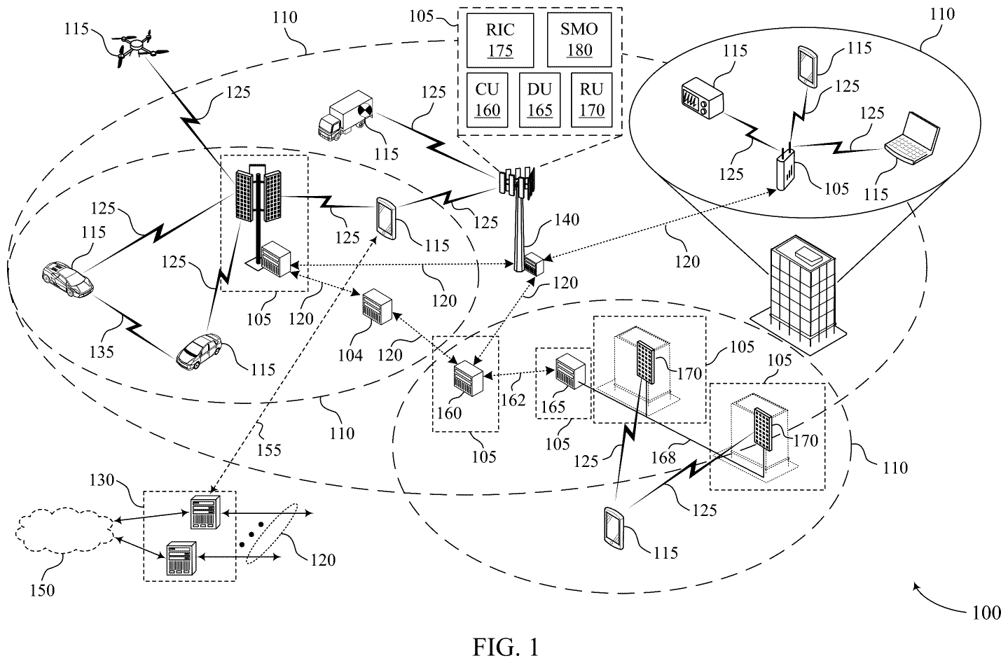

FIG. 1 shows an example of a wireless communications system 100 that supports full transmit power beamforming for SU-MIMO transmission in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support full transmit power beamforming for SU-MIMO transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A network entity 105 may obtain an SU-MIMO channel between the network entity 105 and a UE 115. The SU-MIMO channel may correspond to a set of multiple SU-MIMO layers. The network entity 105 may generate a transformed channel from the SU-MIMO channel based on a selection of the set of multiple SU-MIMO layers. The selection may be based on an SVD of the SU-MIMO channel, or a set of receive antennas at the UE 115, or a combination thereof. The network entity 105 may generate an intermediate beamformer based on the transformed channel, and the network entity 105 may generate a per antenna full transmit power beamformer based on the intermediate beamformer. The network entity 105 may output a beamformed signal to the UE 115, and a respective beamforming weight for each SU-MIMO layer of the set of multiple SU-MIMO layers may be based on the per antenna full transmit power beamformer.

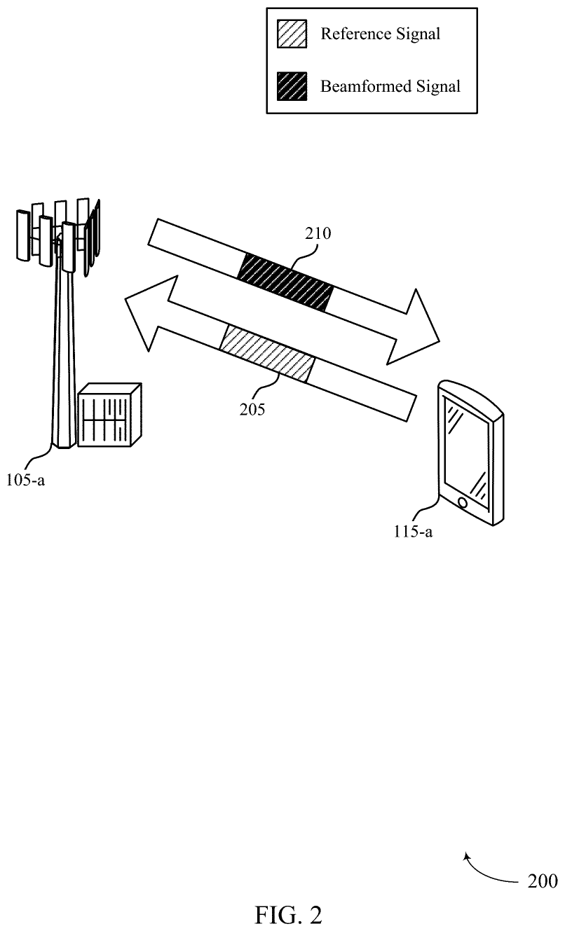

FIG. 2 shows an example of a wireless communications system 200 that supports full transmit power beamforming for SU-MIMO transmission in accordance with one or more aspects of the present disclosure. The wireless communications system 200 may implement, or may be implemented by, aspects of the wireless communications system 100. For example, the wireless communications system 200 may include a UE 115-a and a network entity 105-a, which may be examples of corresponding devices as described herein.

In some examples, the network entity 105-a may configure the UE 115-a for SU-MIMO transmissions (e.g., a beamformed signal 210). The UE 115-a may include multiple receive antennas. Based on the SU-MIMO configuration, the beamformed signal 210 may use a beamforming scheme that utilizes multiple SU-MIMO layers of an SU-MIMO channel between the network entity 105-a and the UE 115-a. Each of the SU-MIMO layers may correspond to a spatial stream (e.g., a spatial layer) between a transmit antenna of the network entity 105-a and a receive antenna of the multiple receive antennas at the UE 115-a. In some cases, the network entity 105-a may obtain the SU-MIMO channel based on a reference signal 205 that the network entity 105-a receives from the UE 115-a. For example, the UE 115-a may transmit a sounding reference signal (SRS) or may transmit a CSI report (e.g., type II CSI report) that includes compressed CSI of a downlink MIMO channel. Based on the SRS or the CSI report, the network entity 105-a may assume uplink-downlink channel reciprocity and may determine or obtain the SU-MIMO channel.

The SU-MIMO channel between the network entity 105-a and the UE 115-a may be denoted by a matrix H. A beamformer that the network entity 105-a uses to send a quantity (e.g., K) of independent data layers may be denoted by W_{BF}. In other words, each of the K independent data layers may be assigned a respective beamforming weight. The K layer data symbols (e.g., which include data to be included in the beamformed signal 210) may be denoted by S. Interference and noise at the UE 115-a receiving the beamformed signal 210 may be denoted by a vector Z. Accordingly, the received beamformed signal 210, Y, may be described in Equation 1.

Y=HW_{BF}S+Z (1)

Each transmit antenna at the network entity 105-a may be driven by an independent power amplifier and may each have a maximum transmit power threshold based on the power amplifier. With the per transmit antenna maximum transmit power threshold, the network entity 105-a may expend time and computation resources to compute beamforming weights for each of the SU-MIMO layers such that the transmit power for each transmit antenna satisfies the maximum transmit power threshold. However, such computation may increase latency of communications and increase power consumption at the network entity 105-a. In some cases, computations of beamforming weights may be excessively long and may fail to satisfy configured time windows or thresholds for efficient communication with the UE 115-a.

In accordance with examples described herein, the network entity 105-a may utilize a per antenna full transmit power beamformer to assign beamforming weights to each of the multiple SU-MIMO layers for the beamformed signal 210. By using the per antenna full transmit power beamformer, the network entity 105-a may support increased data rates and an increased transmit power utilization of transmit power amplifiers at the network entity 105-a, thereby supporting a greater efficiency of power utilization and increased reliability of communications with the UE 115-a.

To generate the per antenna full transmit power beamformer, the network entity 105-a may transform the SU-MIMO channel (e.g., raw SU-MIMO channel) based on a selection of the multiple SU-MIMO layers. For example, the network entity 105-a may generate the beamforming weights of the per antenna full transmit power beamformer based on a subset of the SU-MIMO channel. In some examples, the network entity 105-a may perform an SVD of the SU-MIMO channel, thereby obtaining an SVD projected channel. In some examples, performing the SVD processing of the SU-MIMO channel may decrease inter-layer interference of the multiple SU-MIMO layers. The network entity 105-a may apply an intermediate beamformer (e.g., a base beamformer) to the SVD projected channel. The intermediate beamformer may be a matched filter beamformer or an equal gain beamformer. The network entity 105-a may derive the per antenna full transmit power beamformer based on the intermediate beamformer and a distribution of transmit power (e.g., equal distribution or normalization of power) across the multiple SU-MIMO layers.

In some examples, based on the per antenna full transmit power beamformer, the network entity 105-a may output the beamformed signal 210 at an equal transmit power across the multiple SU-MIMO layers. Accordingly, the respective beamforming weights for each layer of the multiple SU-MIMO layers in the per antenna full transmit power beamformer may share a same amplitude. In other examples, the network entity 105-a may perform a power normalization on each transmit power antenna of multiple transmit antennas at the network entity 105-a. In such examples, the respective beamforming weights for each layer of the multiple SU-MIMO layers of the per antenna full transmit power beamformer may be derived based on the power normalization.

In some examples, the network entity 105-a may select a subset of the SU-MIMO channel based on a selection of a set of receive antennas at the UE 115-a. The selection of the set of receive antennas may be based on one or more metric functions that the network entity 105-a applies to the SU-MIMO channel. The network entity 105-a may apply an intermediate beamformer to the selected subset of the SU-MIMO channel. The intermediate beamformer may be a zero-forcing beamformer or a regularized zero-forcing beamformer. The network entity 105-a may derive the per antenna full transmit power beamformer based on the intermediate beamformer and a normalization of transmit power across the multiple SU-MIMO layers. That is, the network entity 105-a may perform a power normalization on each transmit power antenna of multiple transmit antennas at the network entity 105-a. The respective beamforming weights for each layer of the multiple SU-MIMO layers of the per antenna full transmit power beamformer may be derived based on the power normalization.

In some examples, the per antenna full transmit power beamformer may assign beamforming weights on a per resource block basis and may interpolate the beamforming weights for a resource block to multiple resource elements within the resource block. For example, the per antenna full transmit power beamformer may compute separate beamforming weights for each resource block of the beamformed signal 210. However, in some cases, to reduce complexity of computation (e.g., to reduce power consumption, reduce processing), the network entity 105-a may use the per antenna full transmit power beamformer to assign beamforming weights for a subset (e.g., group) of resource blocks, and may similarly interpolate the beamforming weights to each resource element of the set of resource blocks.

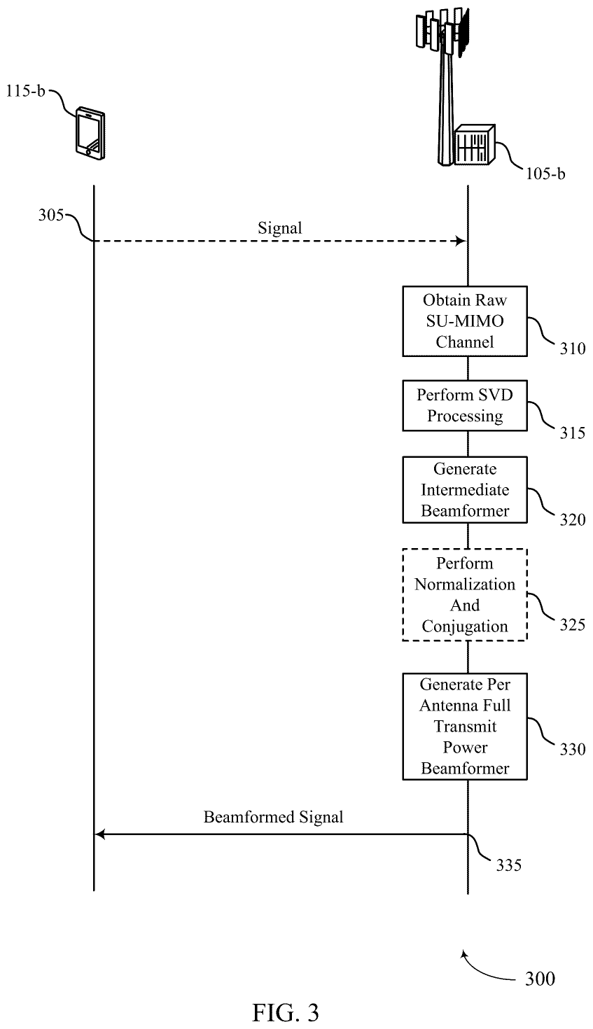

FIG. 3 shows an example of a process flow 300 that supports full transmit power beamforming for SU-MIMO transmission in accordance with one or more aspects of the present disclosure. The process flow 300 may implement, or may be implemented by, aspects of the wireless communications system 100 and the wireless communications system 200. For example, the process flow 300 may include a UE 115-b and a network entity 105-b, which may be examples of corresponding devices as described herein.

In the following description of the process flow 300, the operations between the UE 115-b and the network entity 105-b may be transmitted in a different order than the example order shown, or the operations performed by the UE 115-b and the network entity 105-b may be performed in different orders or at different times. Some operations may also be omitted from the process flow 300, and other operations may be added to the process flow 300.

At 305, the network entity 105-b may receive a signal from the UE 115-b. In some examples, the signal may be an SRS. In other examples, the signal may be a CSI report. Based on the received signal, at 310, the network entity 105-b may obtain an SU-MIMO channel (e.g., raw SU-MIMO channel) between the network entity 105-b and the UE 115-b. The SU-MIMO channel may include channel information for multiple SU-MIMO layers.

At 315, the network entity 105-b may perform an SVD of the SU-MIMO channel to obtain a subset of a left singular matrix (e.g., or a right singular matrix) associated with the SU-MIMO channel. The subset of the left singular matrix may be denoted by U_{K}, which may correspond to the K strongest column vectors (e.g., the first K columns correspond to the largest K singular values of H) in the left singular matrix U of H. The value K may be the scheduled number of SU-MIMO layers for transmission to the UE 115-b. The subset of the left singular matrix (e.g., the K strongest column vectors) may satisfy a channel quality threshold (e.g., based on an SNR, a signal strength, an estimated throughput, or other channel quality measurement). The network entity 105-a may perform the SVD processing by projecting the SU-MIMO channel onto dominant eigen modes at the receive side as in equation 2, where Hsvd is an SVD projection of the SU-MIMO channel.

$$H s v d = {U}_{K}^{H} H \qquad ( 2 )$$

Additionally, or alternatively, the network entity 105-a may obtain the subset of the left singular matrix by an equivalent eigen decomposition (EVD) operation based on equation 3.

$$H \cdot {H}^{H} = U {Λ}^{2} {U}^{H} \qquad ( 3 )$$

In some examples, the network entity 105-b may obtain the subset of the left singular matrix U_{K} per resource block. However, in some examples, the matrix U_{K} may be obtained for a resource granularity different from a resource block. For example, the network entity 105-a may obtain the subset of the left singular matrix U_{K} for a set of frequency resources (e.g., a set of resource blocks), which in some examples may be the set of frequency resources that is scheduled for a SU-MIMO transmission to the UE 115-b.

At 320, the network entity 105-b may generate an intermediate beamformer based on the SVD projected channel. The intermediate beamformer may be a matched filter beamformer, and the network entity 105-b may apply the matched filter beamformer to the transformed channel.

At 325, the network entity 105-b may perform per layer normalization and conjugation for each SU-MIMO layer of the multiple SU-MIMO layers, according to equation 4.

$${e}^{{∢ Hsvd}_{k , :}^{H}} = {( \frac{H s v {d}_{k , :}}{abs ( {Hsvd}_{k , :} )} )}^{H} , k = 1 , 2 , … , K \qquad ( 4 )$$

At 330, the network entity 105-b may generate a per antenna full transmit power beamformer based on the intermediate beamformer. For each layer of the multiple SU-MIMO layers, the beamforming weight of the per antenna full transmit power beamformer may be normalized to full power on each transmit antenna. The network entity 105-b may apply a power allocation for each beamforming weight. In some examples, the power allocation may assign equal transmit power across the multiple SU-MIMO layers. In such examples, an amplitude of the respective beamforming weight for each SU-MIMO layer of the multiple SU-MIMO layers may be the same. The equal transmit power across SU-MIMO layers may be applied according to equation 5.

$${W}_{B F , k} = \sqrt{\frac{1}{K}} {e}^{{∢ Hsvd}_{k , :}^{H}} = \sqrt{\frac{1}{K}} {( \frac{H s v {d}_{k , :}}{abs ( {Hsvd}_{k , :} )} )}^{H} , k = 1 , 2 , … , K \qquad ( 5 )$$

In other examples, the network entity 105-b may perform a power normalization of the per antenna full power transmit power beamformer on each transmit antenna of a set of transmit antennas at the network entity 105-b. The per transmit antenna full power normalization processing may normalize an average transmit power of each transmit antenna to a full power of the transmit antenna according to equation 6.

$${W}_{BF} = [ \begin{matrix}\frac{{V}_{1 , :}}{sqrt ( {V}_{1 , :} {V}_{1 , :}^{H} )} \\ ⋮ \\ \frac{{V}_{{N}_{T , :}}}{sqrt ( {V}_{Nt , :} {V}_{{N}_{T , :}}^{H} )}\end{matrix} ] \qquad ( 6 )$$

In an example, in a 2-layer MIMO beamforming, the subset of the left singular matrix may be denoted by a vector [a₁, a₂, . . . , a_{N}_{_{T}}] and a vector [b₁, b₂, . . . , b_{N}_{_{T}}], which may be the two strongest right singular vectors of H. To perform the power normalization, the network entity 105-b may normalize the average power on each row of the SU-MIMO channel to the maximum average power as in equation 7, which may result in the per antenna full transmit power beamformer.

$$Norm ( [ \begin{matrix}{a}_{1} & {b}_{1} \\ {a}_{2} & {b}_{2} \\ ⋮ & ⋮ \\ {a}_{{N}_{T}} & {b}_{{N}_{T}}\end{matrix} ] ) = [ \begin{matrix}\frac{{a}_{1}}{\sqrt{{a}_{1}^{2} + {b}_{1}^{2}}} & \frac{{b}_{1}}{\sqrt{{a}_{1}^{2} + {b}_{1}^{2}}} \\ ⋮ & ⋮ \\ \frac{{a}_{{N}_{T}}}{\sqrt{{a}_{{N}_{T}}^{2} + {b}_{{N}_{T}}^{2}}} & \frac{{b}_{{N}_{T}}}{\sqrt{{a}_{{N}_{T}}^{2} + {b}_{{N}_{T}}^{2}}}\end{matrix} ] \qquad ( 7 )$$

At 335, the network entity 105-b may transmit the beamformed signal to the UE 115-b. A respective beamforming weight for each SU-MIMO layer of the multiple SU-MIMO layers may be based on the per antenna full transmit power beamformer.

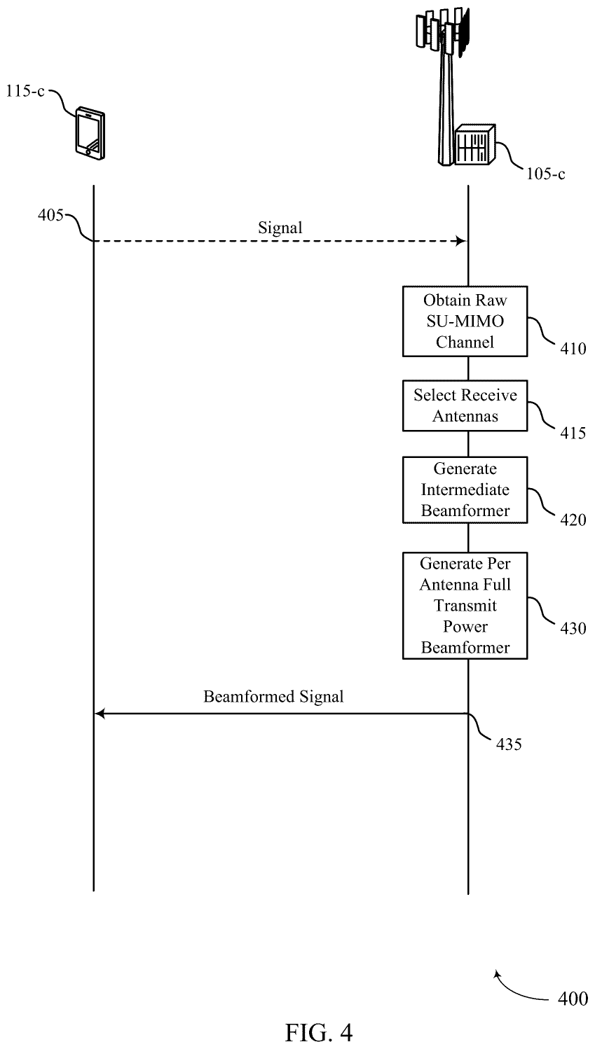

FIG. 4 shows an example of a process flow 400 that supports full transmit power beamforming for SU-MIMO transmission in accordance with one or more aspects of the present disclosure. The process flow 400 may implement, or may be implemented by, aspects of the wireless communications system 100 and the wireless communications system 200. For example, the process flow 400 may include a UE 115-c and a network entity 105-c, which may be examples of corresponding devices as described herein.

In the following description of the process flow 400, the operations between the UE 115-c and the network entity 105-c may be transmitted in a different order than the example order shown, or the operations performed by the UE 115-c and the network entity 105-c may be performed in different orders or at different times. Some operations may also be omitted from the process flow 400, and other operations may be added to the process flow 400.

At 405, the network entity 105-c may receive a signal from the UE 115-c. In some examples, the signal may be an SRS. In other examples, the signal may be a CSI report. Based on the received signal, at 410, the network entity 105-c may obtain an SU-MIMO channel (e.g., raw SU-MIMO channel) between the network entity 105-c and the UE 115-c. The SU-MIMO channel may include channel information for multiple SU-MIMO layers.

At 415, the network entity 105-c may select a set of receive antennas based on applying one or more functions to the SU-MIMO channel. The network entity 105-c may be scheduled with a non-full rank SU-MIMO transmission to the UE 115-c, and a number of SU-MIMO layers may be smaller than a number of receive antennas at the UE 115-c. The one or more functions (e.g., metric functions) may be preconfigured at the network entity 105-c. The one or more functions may be based on a determinate of a channel correlation matrix, which may be denoted by A. AH. The one or more functions may be any of equations 8 through 10, where Al is composed of a subset of rows of the SU-MIMO channel matrix H.

$$metricFunc 1 ( \hat{H} ) = abs ( det ( \hat{H} \cdot {\hat{H}}^{H} ) ) \qquad ( 8 )$$

$$metr i c Func 2 ( \hat{H} ) = 2 sum ( diag ( \hat{H} \cdot {\hat{H}}^{H} ) ) - sum ( abs ( \hat{H} \cdot {\hat{H}}^{H} ) ) \qquad ( 9 )$$

$$metr i cFunc 3 ( \hat{H} ) = \frac{sum ( diag ( \hat{H} \cdot {\hat{H}}^{H} ) )}{sum ( abs ( \hat{H} \cdot {\hat{H}}^{H} ) ) - sum ( diag ( \hat{H} \cdot {\hat{H}}^{H} ) )} \qquad ( 10 )$$

The network entity 105-c may select (e.g., down select) a subset of the SU-MIMO channel, Ĥ_{b}=Hᵣₛₑₜ, based on the selected set of receive antennas, rset.

In some examples, the selected set of receive antennas apply per resource block of the SU-MIMO channel, or the selected set of receive antennas may be performed over a set of resource blocks or over the entirety of the scheduled resources for an SU-MIMO transmission.

At 420, the network entity 105-c may generate an intermediate beamformer based on the selected subset of the SU-MIMO channel. The intermediate beamformer may be a zero forcing beamformer or a regularized zero forcing beamformer, and the network entity 105-b may apply the zero forcing beamformer or the regularized zero forcing beamformer to the selected subset of the SU-MIMO channel, as in equation 11. The zero forcing beamformer or the regularized zero forcing beamformer may be applied per unit frequency resource, such as per resource block.

$${\hat{W}}_{Z F} = {{\hat{H}}_{b}^{H} ( {\hat{H}}_{b} {\hat{H}}_{b}^{H} )}^{- 1} \qquad ( 11 )$$

In other examples, the network entity 105-c may determine a transmit side common transformation matrix, Q_{K}, based on equation 12.

$${Q}_{K} = {( {( {\sum }_{R B s} \hat{H} \cdot {\hat{H}}^{H} )}_{r S e t , r S e t} )}^{- 1} \qquad ( 12 )$$

The intermediate beamformer may be a modified matched filter beamformer, and the network entity 105-c may apply the modified matched filter beamformer on the selected subset of the SU-MIMO channel, Ĥ_{b}, and based on the common transformation matrix Q_{K}, as in equation 13.

$${\hat{W}}_{MF} = {\hat{H}}_{b}^{H} {Q}_{K} \qquad ( 13 )$$

At 430, the network entity 105-c may generate a per antenna full transmit power beamformer based on the intermediate beamformer. For each layer of the multiple SU-MIMO layers, the beamforming weight of the per antenna full transmit power beamformer may be normalized to full power on each transmit antenna. The network entity 105-c may perform a power normalization of the per antenna full power transmit power beamformer on each transmit antenna of a set of transmit antennas at the network entity 105-b. The per transmit antenna full power normalization processing may normalize an average transmit power of each transmit antenna to a full power of the transmit antenna according to equation 14, for the zero forcing beamformer or the regularized zero forcing beamformer, or according to equation 15, for the modified matched filter beamformer.

$${W}_{BF} = [ \begin{matrix}\frac{{\hat{W}}_{{ZF}_{1 , :}}}{sqrt ( {\hat{W}}_{{ZF}_{1 , :}} {\hat{W}}_{{ZF}_{1 , :}}^{H} )} \\ ⋮ \\ \frac{{\hat{W}}_{{ZF}_{{N}_{T , :}}}}{sqrt ( {\hat{W}}_{{ZF}_{{N}_{T , :}}} {\hat{W}}_{{ZF}_{{N}_{T , :}}}^{H} )}\end{matrix} ] \qquad ( 14 )$$

$${W}_{BF} = [ \begin{matrix}\frac{{\hat{W}}_{{MF}_{1 , :}}}{sqrt ( {\hat{W}}_{{MF}_{1 , :}} {\hat{W}}_{{MF}_{1 , :}}^{H} )} \\ ⋮ \\ \frac{{\hat{W}}_{{MF}_{{N}_{T , :}}}}{sqrt ( {\hat{W}}_{{MF}_{{N}_{T , :}}} {\hat{W}}_{{MF}_{{N}_{T , :}}}^{H} )}\end{matrix} ] \qquad ( 15 )$$

At 435, the network entity 105-c may transmit the beamformed signal to the UE 115-c. A respective beamforming weight for each SU-MIMO layer of the multiple SU-MIMO layers may be based on the per antenna full transmit power beamformer.

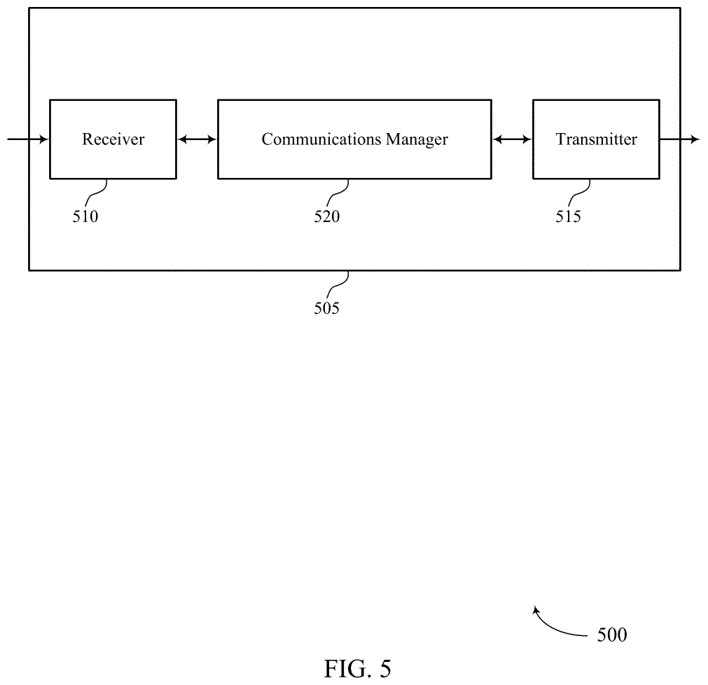

FIG. 5 shows a block diagram 500 of a device 505 that supports full transmit power beamforming for SU-MIMO transmission in accordance with one or more aspects of the present disclosure. The device 505 may be an example of aspects of a network entity 105 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to, individually or collectively, support or enable the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The communications manager 520, the receiver 510, the transmitter 515, or various combinations thereof or various components thereof may be examples of means for performing various aspects of full transmit power beamforming for SU-MIMO transmission as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. For example, the communications manager 520 is capable of, configured to, or operable to support a means for obtaining a single-user, multi-input multi-output (SU-MIMO) channel between the network entity and a UE, where the SU-MIMO channel corresponds to a set of multiple SU-MIMO layers. The communications manager 520 is capable of, configured to, or operable to support a means for generating a transformed channel from the SU-MIMO channel based on a selection of the set of multiple SU-MIMO layers, the selection based on an SVD of the SU-MIMO channel, or a set of receive antennas at the UE, or a combination thereof. The communications manager 520 is capable of, configured to, or operable to support a means for generating an intermediate beamformer based on the transformed channel. The communications manager 520 is capable of, configured to, or operable to support a means for generating a per antenna full transmit power beamformer based on the intermediate beamformer. The communications manager 520 is capable of, configured to, or operable to support a means for outputting a beamformed signal to the UE, where a respective beamforming weight for each SU-MIMO layer of the set of multiple SU-MIMO layers is based on the per antenna full transmit power beamformer.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing and reduced power consumption by reducing computation complexity for determining beamforming weights for SU-MIMO communications.

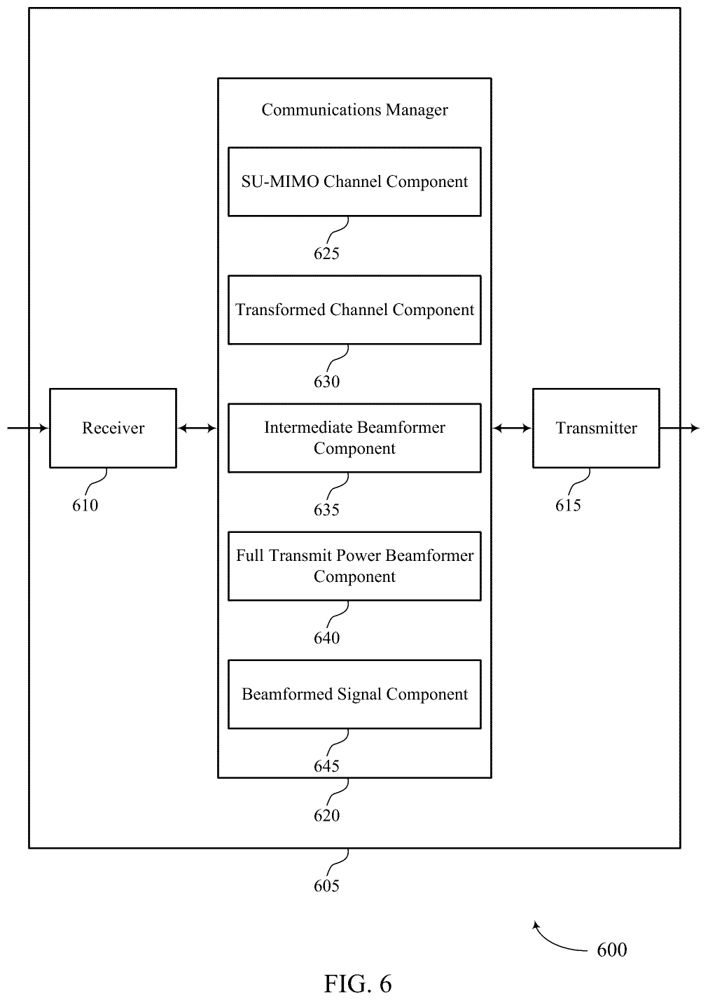

FIG. 6 shows a block diagram 600 of a device 605 that supports full transmit power beamforming for SU-MIMO transmission in accordance with one or more aspects of the present disclosure. The device 605 may be an example of aspects of a device 505 or a network entity 105 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to support the described techniques. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The device 605, or various components thereof, may be an example of means for performing various aspects of full transmit power beamforming for SU-MIMO transmission as described herein. For example, the communications manager 620 may include an SU-MIMO channel component 625, a transformed channel component 630, an intermediate beamformer component 635, a full transmit power beamformer component 640, a beamformed signal component 645, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. The SU-MIMO channel component 625 is capable of, configured to, or operable to support a means for obtaining a single-user, multi-input multi-output (SU-MIMO) channel between the network entity and a UE, where the SU-MIMO channel corresponds to a set of multiple SU-MIMO layers. The transformed channel component 630 is capable of, configured to, or operable to support a means for generating a transformed channel from the SU-MIMO channel based on a selection of the set of multiple SU-MIMO layers, the selection based on an SVD of the SU-MIMO channel, or a set of receive antennas at the UE, or a combination thereof. The intermediate beamformer component 635 is capable of, configured to, or operable to support a means for generating an intermediate beamformer based on the transformed channel. The full transmit power beamformer component 640 is capable of, configured to, or operable to support a means for generating a per antenna full transmit power beamformer based on the intermediate beamformer. The beamformed signal component 645 is capable of, configured to, or operable to support a means for outputting a beamformed signal to the UE, where a respective beamforming weight for each SU-MIMO layer of the set of multiple SU-MIMO layers is based on the per antenna full transmit power beamformer.

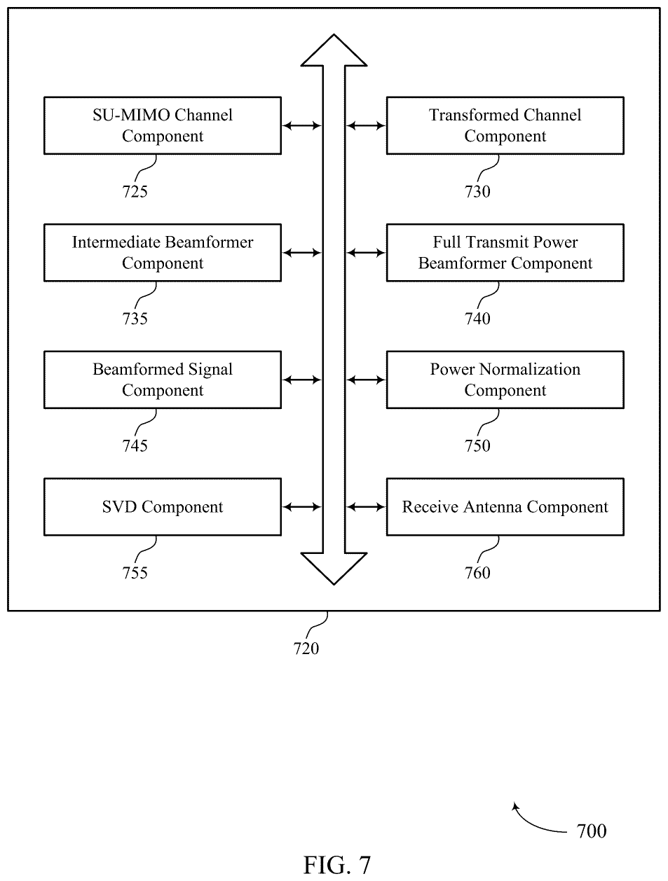

FIG. 7 shows a block diagram 700 of a communications manager 720 that supports full transmit power beamforming for SU-MIMO transmission in accordance with one or more aspects of the present disclosure. The communications manager 720 may be an example of aspects of a communications manager 520, a communications manager 620, or both, as described herein. The communications manager 720, or various components thereof, may be an example of means for performing various aspects of full transmit power beamforming for SU-MIMO transmission as described herein. For example, the communications manager 720 may include an SU-MIMO channel component 725, a transformed channel component 730, an intermediate beamformer component 735, a full transmit power beamformer component 740, a beamformed signal component 745, a power normalization component 750, an SVD component 755, a receive antenna component 760, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 720 may support wireless communications in accordance with examples as disclosed herein. The SU-MIMO channel component 725 is capable of, configured to, or operable to support a means for obtaining a single-user, multi-input multi-output (SU-MIMO) channel between the network entity and a UE, where the SU-MIMO channel corresponds to a set of multiple SU-MIMO layers. The transformed channel component 730 is capable of, configured to, or operable to support a means for generating a transformed channel from the SU-MIMO channel based on a selection of the set of multiple SU-MIMO layers, the selection based on an SVD of the SU-MIMO channel, or a set of receive antennas at the UE, or a combination thereof. The intermediate beamformer component 735 is capable of, configured to, or operable to support a means for generating an intermediate beamformer based on the transformed channel. The full transmit power beamformer component 740 is capable of, configured to, or operable to support a means for generating a per antenna full transmit power beamformer based on the intermediate beamformer. The beamformed signal component 745 is capable of, configured to, or operable to support a means for outputting a beamformed signal to the UE, where a respective beamforming weight for each SU-MIMO layer of the set of multiple SU-MIMO layers is based on the per antenna full transmit power beamformer.

In some examples, to support outputting the beamformed signal, the beamformed signal component 745 is capable of, configured to, or operable to support a means for outputting the beamformed signal at an equal transmit power across the set of multiple SU-MIMO layers based on the per antenna full transmit power beamformer, where an amplitude of the respective beamforming weight for each SU-MIMO layer of the set of multiple SU-MIMO layers is the same.

In some examples, the power normalization component 750 is capable of, configured to, or operable to support a means for performing a power normalization of the per antenna full transmit power beamformer on each transmit antenna of a set of multiple transmit antennas corresponding to the set of multiple SU-MIMO layers, where each SU-MIMO layer of the set of multiple SU-MIMO layers is assigned the respective beamforming weight based on the power normalization.

In some examples, to support generating the transformed channel, the SVD component 755 is capable of, configured to, or operable to support a means for performing the SVD of the SU-MIMO channel to obtain a subset of a left singular matrix associated with the SU-MIMO channel, where the subset of the left singular matrix satisfies a channel quality threshold.

In some examples, the transformed channel is based on a multiplication of the SU-MIMO channel with a Hermitian of the subset of the left singular matrix that satisfies the channel quality threshold.

In some examples, the receive antenna component 760 is capable of, configured to, or operable to support a means for selecting the set of receive antennas based on applying one or more functions to the SU-MIMO channel, where a first quantity of the set of receive antennas is less than a second quantity of the set of multiple SU-MIMO layers.

In some examples, to support outputting the beamformed signal, the beamformed signal component 745 is capable of, configured to, or operable to support a means for outputting the beamformed signal via a set of multiple resource blocks, wherein the respective beamforming weights are calculated for each resource block of the set of multiple resource blocks.

In some examples, the intermediate beamformer component 735 is capable of, configured to, or operable to support a means for applying the matched filter beamformer to the transformed channel, where the respective beamforming weight for each SU-MIMO layer of the set of multiple SU-MIMO layers is based on applying the matched filter beamformer.

In some examples, the intermediate beamformer component 735 is capable of, configured to, or operable to support a means for applying the zero-forcing beamformer or the regularized zero-forcing beamformer to the transformed channel, where the respective beamforming weight for each SU-MIMO layer of the set of multiple SU-MIMO layers is based on applying the zero-forcing beamformer or the regularized zero-forcing beamformer.

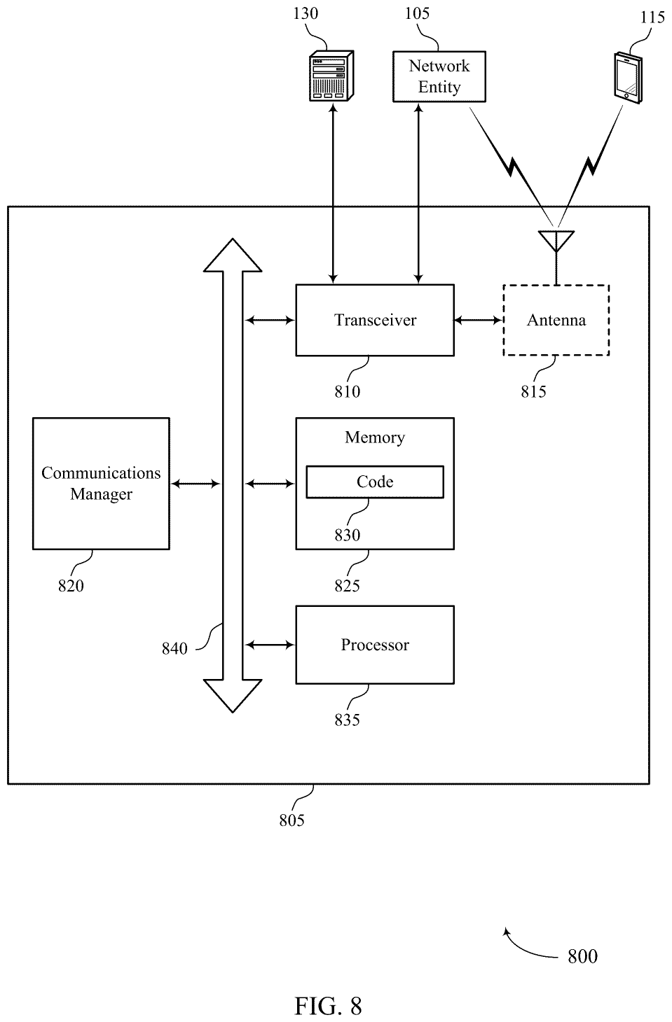

FIG. 8 shows a diagram of a system 800 including a device 805 that supports full transmit power beamforming for SU-MIMO transmission in accordance with one or more aspects of the present disclosure. The device 805 may be an example of or include the components of a device 505, a device 605, or a network entity 105 as described herein. The device 805 may communicate with one or more network entities 105, one or more UEs 115, or any combination thereof, which may include communications over one or more wired interfaces, over one or more wireless interfaces, or any combination thereof. The device 805 may include components that support outputting and obtaining communications, such as a communications manager 820, a transceiver 810, an antenna 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., a communication link 125, a backhaul communication link 120, a midhaul communication link 162, a fronthaul communication link 168).

The at least one memory 825 may include RAM, ROM, or any combination thereof. The at least one memory 825 may store computer-readable, computer-executable code 830 including instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may contain, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting full transmit power beamforming for SU-MIMO transmission). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825). In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with other network entities 105, and may include a controller or scheduler for controlling communications with UEs 115 in cooperation with other network entities 105. In some examples, the communications manager 820 may support an X2 interface within an LTE/LTE-A wireless communications network technology to provide communication between network entities 105.

The communications manager 820 may support wireless communications in accordance with examples as disclosed herein. For example, the communications manager 820 is capable of, configured to, or operable to support a means for obtaining a single-user, multi-input multi-output (SU-MIMO) channel between the network entity and a UE, where the SU-MIMO channel corresponds to a set of multiple SU-MIMO layers. The communications manager 820 is capable of, configured to, or operable to support a means for generating a transformed channel from the SU-MIMO channel based on a selection of the set of multiple SU-MIMO layers, the selection based on an SVD of the SU-MIMO channel, or a set of receive antennas at the UE, or a combination thereof. The communications manager 820 is capable of, configured to, or operable to support a means for generating an intermediate beamformer based on the transformed channel. The communications manager 820 is capable of, configured to, or operable to support a means for generating a per antenna full transmit power beamformer based on the intermediate beamformer. The communications manager 820 is capable of, configured to, or operable to support a means for outputting a beamformed signal to the UE, where a respective beamforming weight for each SU-MIMO layer of the set of multiple SU-MIMO layers is based on the per antenna full transmit power beamformer.

By including or configuring the communications manager 820 in accordance with examples as described herein, the device 805 may support techniques for reduced latency and longer battery life by reducing computation complexity for determining beamforming weights for SU-MIMO communications.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of full transmit power beamforming for SU-MIMO transmission as described herein, or the at least one processor 835 and the at least one memory 825 may be otherwise configured to, individually or collectively, perform or support such operations.

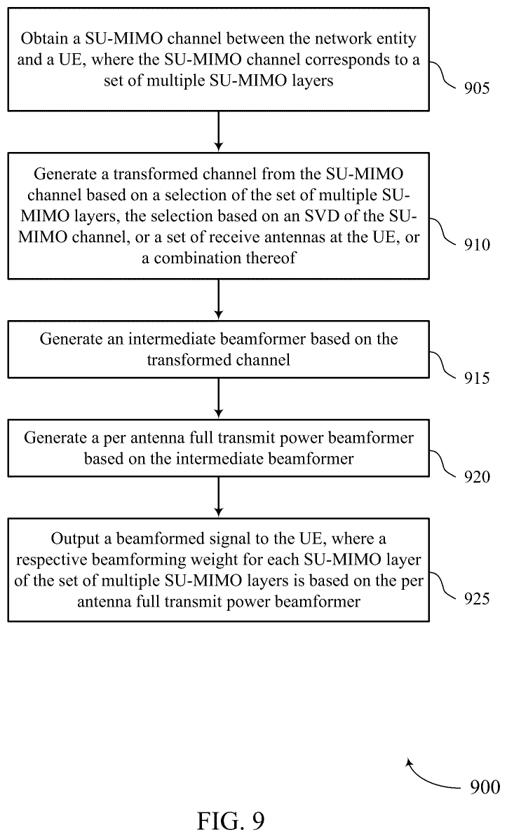

FIG. 9 shows a flowchart illustrating a method 900 that supports full transmit power beamforming for SU-MIMO transmission in accordance with aspects of the present disclosure. The operations of the method 900 may be implemented by a network entity or its components as described herein. For example, the operations of the method 900 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 905, the method may include obtaining a single-user, multi-input multi-output (SU-MIMO) channel between the network entity and a UE, where the SU-MIMO channel corresponds to a set of multiple SU-MIMO layers. The operations of block 905 may be performed in accordance with examples as disclosed herein. In some examples, aspects of the operations of 905 may be performed by an SU-MIMO channel component 725 as described with reference to FIG. 7.

At 910, the method may include generating a transformed channel from the SU-MIMO channel based on a selection of the set of multiple SU-MIMO layers, the selection based on an SVD of the SU-MIMO channel, or a set of receive antennas at the UE, or a combination thereof. The operations of block 910 may be performed in accordance with examples as disclosed herein. In some examples, aspects of the operations of 910 may be performed by a transformed channel component 730 as described with reference to FIG. 7.

At 915, the method may include generating an intermediate beamformer based on the transformed channel. The operations of block 915 may be performed in accordance with examples as disclosed herein. In some examples, aspects of the operations of 915 may be performed by an intermediate beamformer component 735 as described with reference to FIG. 7.

At 920, the method may include generating a per antenna full transmit power beamformer based on the intermediate beamformer. The operations of block 920 may be performed in accordance with examples as disclosed herein. In some examples, aspects of the operations of 920 may be performed by a full transmit power beamformer component 740 as described with reference to FIG. 7.

At 925, the method may include outputting a beamformed signal to the UE, where a respective beamforming weight for each SU-MIMO layer of the set of multiple SU-MIMO layers is based on the per antenna full transmit power beamformer. The operations of block 925 may be performed in accordance with examples as disclosed herein. In some examples, aspects of the operations of 925 may be performed by a beamformed signal component 745 as described with reference to FIG. 7.

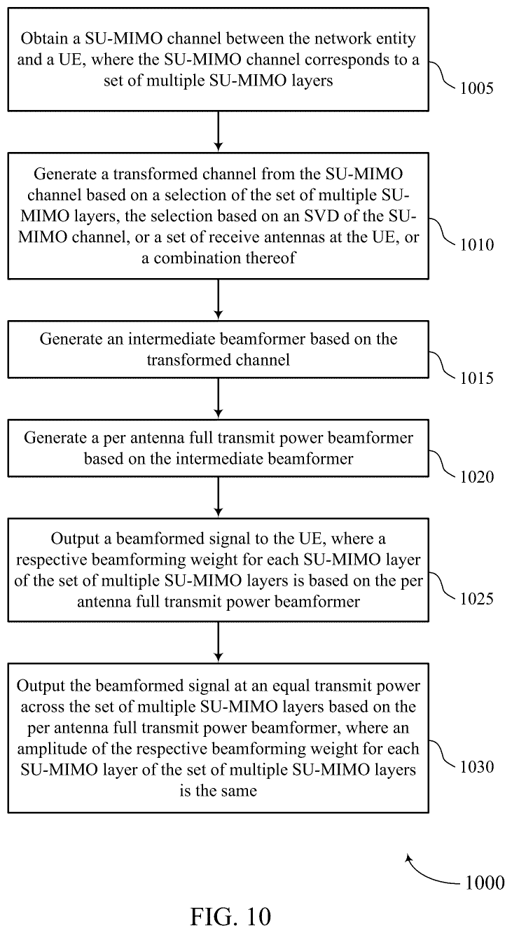

FIG. 10 shows a flowchart illustrating a method 1000 that supports full transmit power beamforming for SU-MIMO transmission in accordance with aspects of the present disclosure. The operations of the method 1000 may be implemented by a network entity or its components as described herein. For example, the operations of the method 1000 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1005, the method may include obtaining a single-user, multi-input multi-output (SU-MIMO) channel between the network entity and a UE, where the SU-MIMO channel corresponds to a set of multiple SU-MIMO layers. The operations of block 1005 may be performed in accordance with examples as disclosed herein. In some examples, aspects of the operations of 1005 may be performed by an SU-MIMO channel component 725 as described with reference to FIG. 7.

At 1010, the method may include generating a transformed channel from the SU-MIMO channel based on a selection of the set of multiple SU-MIMO layers, the selection based on an SVD of the SU-MIMO channel, or a set of receive antennas at the UE, or a combination thereof. The operations of block 1010 may be performed in accordance with examples as disclosed herein. In some examples, aspects of the operations of 1010 may be performed by a transformed channel component 730 as described with reference to FIG. 7.

At 1015, the method may include generating an intermediate beamformer based on the transformed channel. The operations of block 1015 may be performed in accordance with examples as disclosed herein. In some examples, aspects of the operations of 1015 may be performed by an intermediate beamformer component 735 as described with reference to FIG. 7.

At 1020, the method may include generating a per antenna full transmit power beamformer based on the intermediate beamformer. The operations of block 1020 may be performed in accordance with examples as disclosed herein. In some examples, aspects of the operations of 1020 may be performed by a full transmit power beamformer component 740 as described with reference to FIG. 7.

At 1025, the method may include outputting a beamformed signal to the UE, where a respective beamforming weight for each SU-MIMO layer of the set of multiple SU-MIMO layers is based on the per antenna full transmit power beamformer. The operations of block 1025 may be performed in accordance with examples as disclosed herein. In some examples, aspects of the operations of 1025 may be performed by a beamformed signal component 745 as described with reference to FIG. 7.

At 1030, the method may include outputting the beamformed signal at an equal transmit power across the set of multiple SU-MIMO layers based on the per antenna full transmit power beamformer, where an amplitude of the respective beamforming weight for each SU-MIMO layer of the set of multiple SU-MIMO layers is the same. The operations of block 1030 may be performed in accordance with examples as disclosed herein. In some examples, aspects of the operations of 1030 may be performed by a beamformed signal component 745 as described with reference to FIG. 7.

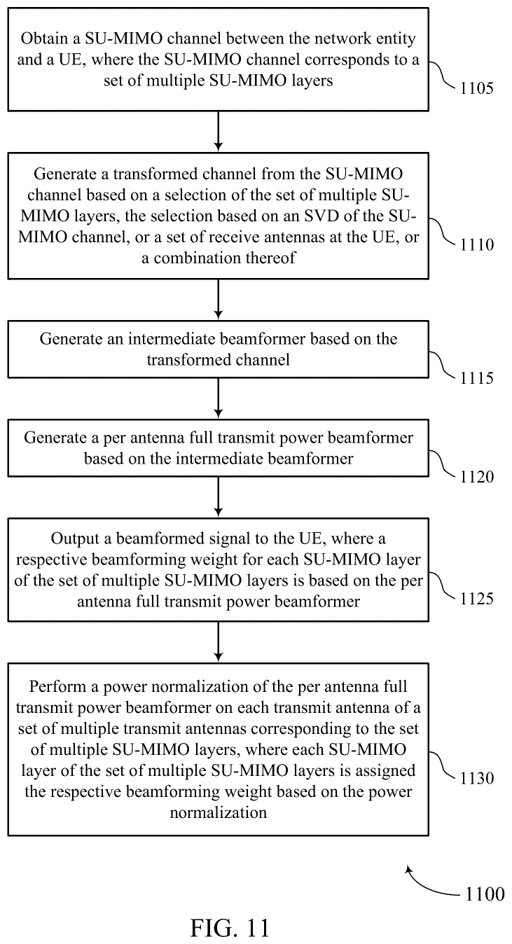

FIG. 11 shows a flowchart illustrating a method 1100 that supports full transmit power beamforming for SU-MIMO transmission in accordance with aspects of the present disclosure. The operations of the method 1100 may be implemented by a network entity or its components as described herein. For example, the operations of the method 1100 may be performed by a network entity as described with reference to FIGS. 1 through 8. In some examples, a network entity may execute a set of instructions to control the functional elements of the network entity to perform the described functions. Additionally, or alternatively, the network entity may perform aspects of the described functions using special-purpose hardware.

At 1105, the method may include obtaining a single-user, multi-input multi-output (SU-MIMO) channel between the network entity and a UE, where the SU-MIMO channel corresponds to a set of multiple SU-MIMO layers. The operations of block 1105 may be performed in accordance with examples as disclosed herein. In some examples, aspects of the operations of 1105 may be performed by an SU-MIMO channel component 725 as described with reference to FIG. 7.

At 1110, the method may include generating a transformed channel from the SU-MIMO channel based on a selection of the set of multiple SU-MIMO layers, the selection based on an SVD of the SU-MIMO channel, or a set of receive antennas at the UE, or a combination thereof. The operations of block 1110 may be performed in accordance with examples as disclosed herein. In some examples, aspects of the operations of 1110 may be performed by a transformed channel component 730 as described with reference to FIG. 7.

At 1115, the method may include generating an intermediate beamformer based on the transformed channel. The operations of block 1115 may be performed in accordance with examples as disclosed herein. In some examples, aspects of the operations of 1115 may be performed by an intermediate beamformer component 735 as described with reference to FIG. 7.

At 1120, the method may include generating a per antenna full transmit power beamformer based on the intermediate beamformer. The operations of block 1120 may be performed in accordance with examples as disclosed herein. In some examples, aspects of the operations of 1120 may be performed by a full transmit power beamformer component 740 as described with reference to FIG. 7.

At 1125, the method may include outputting a beamformed signal to the UE, where a respective beamforming weight for each SU-MIMO layer of the set of multiple SU-MIMO layers is based on the per antenna full transmit power beamformer. The operations of block 1125 may be performed in accordance with examples as disclosed herein. In some examples, aspects of the operations of 1125 may be performed by a beamformed signal component 745 as described with reference to FIG. 7.

At 1130, the method may include performing a power normalization of the per antenna full transmit power beamformer on each transmit antenna of a set of multiple transmit antennas corresponding to the set of multiple SU-MIMO layers, where each SU-MIMO layer of the set of multiple SU-MIMO layers is assigned the respective beamforming weight based on the power normalization. The operations of block 1130 may be performed in accordance with examples as disclosed herein. In some examples, aspects of the operations of 1130 may be performed by a power normalization component 750 as described with reference to FIG. 7.

The following provides an overview of aspects of the present disclosure:

Aspect 1: A method for wireless communications by a network entity, comprising: obtaining an SU-MIMO channel between the network entity and a UE, wherein the SU-MIMO channel corresponds to a plurality of SU-MIMO layers; generating a transformed channel from the SU-MIMO channel based at least in part on a selection of the plurality of SU-MIMO layers, the selection based at least in part on a SVD of the SU-MIMO channel, or a set of receive antennas at the UE, or a combination thereof; generating an intermediate beamformer based at least in part on the transformed channel; generating a per antenna full transmit power beamformer based at least in part on the intermediate beamformer; and outputting a beamformed signal to the UE, wherein a respective beamforming weight for each SU-MIMO layer of the plurality of SU-MIMO layers is based at least in part on the per antenna full transmit power beamformer.

Aspect 2: The method of aspect 1, wherein outputting the beamformed signal comprises: outputting the beamformed signal at an equal transmit power across the plurality of SU-MIMO layers based at least in part on the per antenna full transmit power beamformer, wherein an amplitude of the respective beamforming weight for each SU-MIMO layer of the plurality of SU-MIMO layers is the same.

Aspect 3: The method of any of aspects 1 through 2, further comprising: performing a power normalization of the per antenna full transmit power beamformer on each transmit antenna of a plurality of transmit antennas corresponding to the plurality of SU-MIMO layers, wherein each SU-MIMO layer of the plurality of SU-MIMO layers is assigned the respective beamforming weight based at least in part on the power normalization.

Aspect 4: The method of any of aspects 1 through 3, wherein generating the transformed channel comprises: performing the SVD of the SU-MIMO channel to obtain a subset of a left singular matrix associated with the SU-MIMO channel, wherein the subset of the left singular matrix satisfies a channel quality threshold.

Aspect 5: The method of aspect 4, wherein the transformed channel is based at least in part on a multiplication of the SU-MIMO channel with a Hermitian of the subset of the left singular matrix that satisfies the channel quality threshold.

Aspect 6: The method of any of aspects 1 through 5, further comprising: selecting the set of receive antennas based at least in part on applying one or more functions to the SU-MIMO channel, wherein a first quantity of the set of receive antennas is less than a second quantity of the plurality of SU-MIMO layers.

Aspect 7: The method of any of aspects 1 through 6, wherein outputting the beamformed signal comprises: outputting the beamformed signal via a plurality of resource blocks, wherein the respective beamforming weights are calculated for each resource block of the plurality of resource blocks.

Aspect 8: The method of any of aspects 1 through 7, wherein the intermediate beamformer is a matched filter beamformer, and further comprising: applying the matched filter beamformer to the transformed channel, wherein the respective beamforming weight for each SU-MIMO layer of the plurality of SU-MIMO layers is based at least in part on applying the matched filter beamformer.

Aspect 9: The method of any of aspects 1 through 8, wherein the intermediate beamformer is a zero-forcing beamformer or a regularized zero-forcing beamformer, and further comprising: applying the zero-forcing beamformer or the regularized zero-forcing beamformer to the transformed channel, wherein the respective beamforming weight for each SU-MIMO layer of the plurality of SU-MIMO layers is based at least in part on applying the zero-forcing beamformer or the regularized zero-forcing beamformer.

Aspect 10: A network entity for wireless communications, comprising one or more memories storing processor-executable code, and one or more processors coupled with the one or more memories and individually or collectively operable to execute the code to cause the network entity to perform a method of any of aspects 1 through 9.

Aspect 11: A network entity for wireless communications, comprising at least one means for performing a method of any of aspects 1 through 9.

Aspect 12: A non-transitory computer-readable medium storing code for wireless communications, the code comprising instructions executable by one or more processors to perform a method of any of aspects 1 through 9.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
obtain a single-user, multi-input multi-output (SU-MIMO) channel between the network entity and a user equipment (UE), wherein the SU-MIMO channel corresponds to a plurality of SU-MIMO layers;
generate a transformed channel from the SU-MIMO channel based at least in part on a selection of the plurality of SU-MIMO layers, the selection based at least in part on a singular value decomposition of the SU-MIMO channel, or a set of receive antennas at the UE, or a combination thereof;
generate an intermediate beamformer based at least in part on the transformed channel;
generate a per antenna full transmit power beamformer based at least in part on the intermediate beamformer; and
output a beamformed signal to the UE, wherein a respective beamforming weight for each SU-MIMO layer of the plurality of SU-MIMO layers is based at least in part on the per antenna full transmit power beamformer.

2. The network entity of claim 1, wherein, to output the beamformed signal, the one or more processors are individually or collectively operable to execute the code to cause the network entity to:
output the beamformed signal at an equal transmit power across the plurality of SU-MIMO layers based at least in part on the per antenna full transmit power beamformer, wherein an amplitude of the respective beamforming weight for each SU-MIMO layer of the plurality of SU-MIMO layers is the same.

3. The network entity of claim 1, wherein the one or more processors are individually or collectively further operable to execute the code to cause the network entity to:
perform a power normalization of the per antenna full transmit power beamformer on each transmit antenna of a plurality of transmit antennas corresponding to the plurality of SU-MIMO layers, wherein each SU-MIMO layer of the plurality of SU-MIMO layers is assigned the respective beamforming weight based at least in part on the power normalization.

4. The network entity of claim 1, wherein, to generate the transformed channel, the one or more processors are individually or collectively operable to execute the code to cause the network entity to:
perform the singular value decomposition of the SU-MIMO channel to obtain a subset of a left singular matrix associated with the SU-MIMO channel, wherein the subset of the left singular matrix satisfies a channel quality threshold.

5. The network entity of claim 4, wherein the transformed channel is based at least in part on a multiplication of the SU-MIMO channel with a Hermitian of the subset of the left singular matrix that satisfies the channel quality threshold.

6. The network entity of claim 1, wherein the one or more processors are individually or collectively further operable to execute the code to cause the network entity to:
select the set of receive antennas based at least in part on applying one or more functions to the SU-MIMO channel, wherein a first quantity of the set of receive antennas is less than a second quantity of the plurality of SU-MIMO layers.

7. The network entity of claim 1, wherein, to output the beamformed signal, the one or more processors are individually or collectively further operable to execute the code to cause the network entity to:
output the beamformed signal via a plurality of resource blocks, wherein the respective beamforming weights are calculated for each resource block of the plurality of resource blocks.

8. The network entity of claim 1, wherein the intermediate beamformer is a matched filter beamformer, and wherein the one or more processors are individually or collectively further operable to execute the code to cause the network entity to:
apply the matched filter beamformer to the transformed channel, wherein the respective beamforming weight for each SU-MIMO layer of the plurality of SU-MIMO layers is based at least in part on applying the matched filter beamformer.

9. The network entity of claim 1, wherein the intermediate beamformer is a zero-forcing beamformer or a regularized zero-forcing beamformer, and wherein the one or more processors are individually or collectively further operable to execute the code to cause the network entity to:
apply the zero-forcing beamformer or the regularized zero-forcing beamformer to the transformed channel, wherein the respective beamforming weight for each SU-MIMO layer of the plurality of SU-MIMO layers is based at least in part on applying the zero-forcing beamformer or the regularized zero-forcing beamformer.

10. A method for wireless communications by a network entity, comprising:
obtaining a single-user, multi-input multi-output (SU-MIMO) channel between the network entity and a user equipment (UE), wherein the SU-MIMO channel corresponds to a plurality of SU-MIMO layers;
generating a transformed channel from the SU-MIMO channel based at least in part on a selection of the plurality of SU-MIMO layers, the selection based at least in part on a singular value decomposition of the SU-MIMO channel, or a set of receive antennas at the UE, or a combination thereof;
generating an intermediate beamformer based at least in part on the transformed channel;
generating a per antenna full transmit power beamformer based at least in part on the intermediate beamformer; and
outputting a beamformed signal to the UE, wherein a respective beamforming weight for each SU-MIMO layer of the plurality of SU-MIMO layers is based at least in part on the per antenna full transmit power beamformer.

11. The method of claim 10, wherein outputting the beamformed signal comprises:
outputting the beamformed signal at an equal transmit power across the plurality of SU-MIMO layers based at least in part on the per antenna full transmit power beamformer, wherein an amplitude of the respective beamforming weight for each SU-MIMO layer of the plurality of SU-MIMO layers is the same.

12. The method of claim 10, further comprising:
performing a power normalization of the per antenna full transmit power beamformer on each transmit antenna of a plurality of transmit antennas corresponding to the plurality of SU-MIMO layers, wherein each SU-MIMO layer of the plurality of SU-MIMO layers is assigned the respective beamforming weight based at least in part on the power normalization.

13. The method of claim 10, wherein generating the transformed channel comprises:
performing the singular value decomposition of the SU-MIMO channel to obtain a subset of a left singular matrix associated with the SU-MIMO channel, wherein the subset of the left singular matrix satisfies a channel quality threshold.

14. The method of claim 13, wherein the transformed channel is based at least in part on a multiplication of the SU-MIMO channel with a Hermitian of the subset of the left singular matrix that satisfies the channel quality threshold.

15. The method of claim 10, further comprising:
selecting the set of receive antennas based at least in part on applying one or more functions to the SU-MIMO channel, wherein a first quantity of the set of receive antennas is less than a second quantity of the plurality of SU-MIMO layers.

16. The method of claim 10, wherein outputting the beamformed signal comprises:
outputting the beamformed signal via a plurality of resource blocks, wherein the respective beamforming weights are calculated for each resource block of the plurality of resource blocks.

17. The method of claim 10, wherein the intermediate beamformer is a matched filter beamformer, further comprising:
applying the matched filter beamformer to the transformed channel, wherein the respective beamforming weight for each SU-MIMO layer of the plurality of SU-MIMO layers is based at least in part on applying the matched filter beamformer.

18. The method of claim 10, wherein the intermediate beamformer is a zero-forcing beamformer or a regularized zero-forcing beamformer, further comprising:
applying the zero-forcing beamformer or the regularized zero-forcing beamformer to the transformed channel, wherein the respective beamforming weight for each SU-MIMO layer of the plurality of SU-MIMO layers is based at least in part on applying the zero-forcing beamformer or the regularized zero-forcing beamformer.

19. A network entity for wireless communications, comprising:
means for obtaining a single-user, multi-input multi-output (SU-MIMO) channel between the network entity and a user equipment (UE), wherein the SU-MIMO channel corresponds to a plurality of SU-MIMO layers;
means for generating a transformed channel from the SU-MIMO channel based at least in part on a selection of the plurality of SU-MIMO layers, the selection based at least in part on a singular value decomposition of the SU-MIMO channel, or a set of receive antennas at the UE, or a combination thereof;
means for generating an intermediate beamformer based at least in part on the transformed channel;
means for generating a per antenna full transmit power beamformer based at least in part on the intermediate beamformer; and
means for outputting a beamformed signal to the UE, wherein a respective beamforming weight for each SU-MIMO layer of the plurality of SU-MIMO layers is based at least in part on the per antenna full transmit power beamformer.

20. The network entity of claim 19, wherein the means for outputting the beamformed signal comprise:
means for outputting the beamformed signal at an equal transmit power across the plurality of SU-MIMO layers based at least in part on the per antenna full transmit power beamformer, wherein an amplitude of the respective beamforming weight for each SU-MIMO layer of the plurality of SU-MIMO layers is the same.

21. The network entity of claim 19, further comprising:
means for performing a power normalization of the per antenna full transmit power beamformer on each transmit antenna of a plurality of transmit antennas corresponding to the plurality of SU-MIMO layers, wherein each SU-MIMO layer of the plurality of SU-MIMO layers is assigned the respective beamforming weight based at least in part on the power normalization.

22. The network entity of claim 19, wherein the means for generating the transformed channel comprise:
means for performing the singular value decomposition of the SU-MIMO channel to obtain a subset of a left singular matrix associated with the SU-MIMO channel, wherein the subset of the left singular matrix satisfies a channel quality threshold.

23. The network entity of claim 22, wherein the transformed channel is based at least in part on a multiplication of the SU-MIMO channel with a Hermitian of the subset of the left singular matrix that satisfies the channel quality threshold.

24. The network entity of claim 19, further comprising:
means for selecting the set of receive antennas based at least in part on applying one or more functions to the SU-MIMO channel, wherein a first quantity of the set of receive antennas is less than a second quantity of the plurality of SU-MIMO layers.

25. The network entity of claim 19, wherein the means for outputting the beamformed signal comprise:
means for outputting the beamformed signal via a plurality of resource blocks, wherein the respective beamforming weights are calculated for each resource block of the plurality of resource blocks.

26. The network entity of claim 19, wherein the intermediate beamformer is a matched filter beamformer, further comprising:
means for applying the matched filter beamformer to the transformed channel, wherein the respective beamforming weight for each SU-MIMO layer of the plurality of SU-MIMO layers is based at least in part on applying the matched filter beamformer.

27. The network entity of claim 19, wherein the intermediate beamformer is a zero-forcing beamformer or a regularized zero-forcing beamformer, further comprising:
means for applying the zero-forcing beamformer or the regularized zero-forcing beamformer to the transformed channel, wherein the respective beamforming weight for each SU-MIMO layer of the plurality of SU-MIMO layers is based at least in part on applying the zero-forcing beamformer or the regularized zero-forcing beamformer.

28. A non-transitory computer-readable medium storing code for wireless communications, the code comprising instructions executable by one or more processors to:
obtain a single-user, multi-input multi-output (SU-MIMO) channel between a network entity and a user equipment (UE), wherein the SU-MIMO channel corresponds to a plurality of SU-MIMO layers;
generate a transformed channel from the SU-MIMO channel based at least in part on a selection of the plurality of SU-MIMO layers, the selection based at least in part on a singular value decomposition of the SU-MIMO channel, or a set of receive antennas at the UE, or a combination thereof;
generate an intermediate beamformer based at least in part on the transformed channel;
generate a per antenna full transmit power beamformer based at least in part on the intermediate beamformer; and
output a beamformed signal to the UE, wherein a respective beamforming weight for each SU-MIMO layer of the plurality of SU-MIMO layers is based at least in part on the per antenna full transmit power beamformer.

29. The non-transitory computer-readable medium of claim 28, wherein the instructions to output the beamformed signal are executable by the one or more processors to:
output the beamformed signal at an equal transmit power across the plurality of SU-MIMO layers based at least in part on the per antenna full transmit power beamformer, wherein an amplitude of the respective beamforming weight for each SU-MIMO layer of the plurality of SU-MIMO layers is the same.

30. The non-transitory computer-readable medium of claim 28, wherein the instructions are further executable by the one or more processors to:
perform a power normalization of the per antenna full transmit power beamformer on each transmit antenna of a plurality of transmit antennas corresponding to the plurality of SU-MIMO layers, wherein each SU-MIMO layer of the plurality of SU-MIMO layers is assigned the respective beamforming weight based at least in part on the power normalization.
